(19) United States
(12) Patent Application Publication
(10) Pub. No.: US 2015/0102151 A1
(43) Pub. Date: Apr. 16, 2015

(54) RETRACTABLE CORD REEL WITH ELECTRICAL CONTACTS MOUNTED ON AN AXIAL MOVABLE SPOOL

(71) Applicant: Response Engineering, Inc., North Hampton, NH (US)

(72) Inventor: Richard SKOWRONSKI, North Hampton, NH (US)

(21) Appl. No.: 14/515,059

(22) Filed: Oct. 15, 2014

Related U.S. Application Data
(60) Provisional application No. 61/961,417, filed on Oct. 15, 2013.

(51) Int. Cl. H02G 11/02; B65H 75/44

(52) U.S. Cl. CPC H02G 11/02; B65H 75/4481; B65H 75/4471
USPC 242/394

(57) ABSTRACT

A novel retractable cord reel with electrical contacts that engage when the spool is locked from retraction. The spool moves axially to engage stationary electrical contacts mounted to the cord reel housing. These stationary contacts are typically connected to a stationary cord that is routed out of the cord reel for connection to another device, or they can be connected to devices or electronics contained inside the cord reel housing. When the spool is one axial position, the contacts are disengaged and the spool can rotate. When the spool is in the opposite axial position, the spool can engage a feature on the housing that locks the spool from rotation while engaging electrical contacts mounted on the spool with stationary contacts mounted on the housing.

### CROSS-REFERENCE TO RELATED APPLICATIONS

The application is claims priority from prior U.S. Provisional Patent Application No. 61/961,417, filed on Oct. 15, 2013, the entire disclosure of which application is incorporated by reference in its entirety.

### FIELD OF THE INVENTION

The present invention relates generally to a retractable cord reel apparatus, and more specifically relates to a retractable cord reel with wire or cable management.

### BACKGROUND OF THE INVENTION

Retractable cord reels have been used in various applications to retractably store various types of wires, cords and cables. Typically, a reel might have a stationary end and a retractable end. The retractable end is typically wound on a rotating spool within the cord reel which carries a wire or cable capable of extension from and retraction back into the reel as the cord is unwound from then rewound back onto the rotating spool. The stationary end does not move during extension or retraction. Such a configuration reduces the mess typically associated with loose wires, as well as dangers related to loose cords which can, for example, become damaged creating electrical hazards or get in the way such as becoming a tripping hazard.

One type of prior art cord reel uses sliding electrical contacts to achieve electrical continuity between the retractable cord carried on the rotating spool and the stationary cord which is typically attached to the stationary cord reel housing. The sliding contacts in this brush and slip ring cord reel can corrode, wear out, accumulate dirt or encounter other problems that may interfere with proper conduction of electricity or electrical signals. This is particularly a problem at low voltages where electricity is unable to arc through a small gap or dirt and result in an open circuit.

Another type of cord reel can maintain continuous electrical continuity between the rotating spool and the stationary housing without any moving electrical contacts. This type of cord reel instead uses a dedicated internal flat cable to connect the rotating spool with the stationary housing. The internal cable has a flat configuration and winds between a loose coil and a tight coil as the spool is rotated. Examples of this type of cord reel can be seen in U.S. Pat. No. 5,535,960 with inventors Richard Skowronski et al and U.S. Pat. No. 5,094,396 with inventor Paul C. Burke, U.S. Pat. No. 6,372,988 with inventors Paul C. Burke et al., and U.S. patent application Ser. No. 13/947,460 with inventor Richard Skowronski.

Still, another type of cord reel provides electrical contact only when the spool is locked from rotation as described in U.S. Pat. No. 8,123,010 with inventors Richard Skowronski et al. Cord reels such as shown in U.S. Pat. No. 8,123,010 with inventors Richard Skowronski et al, have electrical contacts mounted on a moving ratchet that engage electrical contacts mounted on the rotating spool only when the spool is locked from rotation by the ratchet. This system avoids problems associated with brush and slip ring cord reel such as friction, wear, and the undesirable “scratchy” sound during rotation, and some of the dirt accumulation issues. Although these type cord reels do not provide continuous continuity during extension and retraction of the retractable cable, they are economical to manufacture and suitable for low cost high volume applications such as portable consumer electronics.

One significant deficiency of the 8,123,010 type cord reel is that when the ratchet disengages from the spool for cord retraction, there is nothing preventing or regulating rotation of the spool. When the ratchet is disengaged, the spool can “freewheel” in a high speed uncontrolled retraction of the retractable cord. When a cord is retracted at high speed, it can whip and cause damage to the cord, the cord reel or the cord connector, damage to things near the cord or cord reel, and potentially injure a person in the vicinity. Though devices can be added to the cord reel to regulate cord retraction, they are usually cost prohibitive in low cost high volume markets.

While simply holding on to the cord during retraction would likely be sufficient to regulate retraction, users are not always able or willing to do so to retract the cord in a controlled manner. As can be seen above, there is a need for a low cost high volume cord reel that has the ability to regulate cord retraction without the cost of adding costly devices or mechanisms.

### SUMMARY OF THE INVENTION

The presently claimed invention relates to one or more of the following features, elements or combinations thereof.

A novel retractable cord reel of the type that has electrical contacts that engage when the spool is locked from retraction. Instead of prior art cord reels such as the U.S. Pat. No. 8,123,010 that have a moving ratchet with electrical contacts that engage the contacts on and stop rotation of the spool, in the presently claimed invention the spool moves axially to engage stationary electrical contacts mounted to the cord reel housing. These stationary contacts are typically connected to a stationary cord that is routed out of the cord reel for connection to another device, or they can be connected to devices or electronics contained inside the cord reel housing. When the spool is one axial position, the contacts are disengaged and the spool can rotate. When the spool is in the opposite axial position, the spool can engage a feature, device or mechanism on the housing that locks the spool from rotation while engaging electrical contacts mounted on the spool with stationary contacts mounted on the housing.

A means for moving the spool from one axial position to another such as a button, spring, cam, rocker, pawl, lever, follower, clutch, ball, roller or combination thereof controls the axial position of the spool and whether the spool is free to rotate or locked from rotation with the electrical contacts engaged. For example, portions of the spool can protrude through openings in the housing and the user can manually push the spool in one axial direction to engage the housing and contacts, or in the other direction to disengage the spool from the housing and contacts allowing the cord to retract. The user could push directly on spool portions, or on actuators that move the spool. Alternatively, the spool can be biased in one or the other direction with a spring, and the user can push the spool in the direction opposing the spring. Or a combination of these features can selectively move the spool from an axial position where the spool is locked from rotation with electrical contacts engaged, and another axial position where the contacts are disengaged and the spool is free to rotate.

In one variation, the spool is biased toward the side of the housing that has the electrical contacts and locking feature such as a cam. Here, the natural state of the spool is in the locked position with the cam engaging the spool. The cam pushes the spool away from the housing during cord extension so the electrical contacts do not rub during extension. During retraction, the cam allows the spool to move axially to achieve electrical continuity between the contacts on the spool and contacts in the housing. In this variation, the user simply pulls the extendable cord from the housing and when the desired extension is achieved, the cord is allowed to retract slightly until the cam allows the spring biased spool to move axially until rotation is locked and contacts are engaged. A portion of the center of the spool protrudes through an opening in the housing and is accessible to the user. Pressing the exposed portion of the spool causes the spool to move axially against the spring causing the cam and contacts to disengage and the spool to rotate and the cord to retract.

Once the cam is disengaged from the spool, the spool can rotate to retract the cord. Since the users hand is in contact with the spool, the friction of the users hand against the exposed button portion of the rotating spool will slow and regulate rotation of the spool and therefore regulate cord retraction speed. If the user exerts high pressure against the spool, the increased friction will stop the spool from rotating. Light pressure will allow controlled rotation and cord retraction. If the user removes his hand, then the spool will again move axially by the axial biasing spring and the cam will reengage the spool stopping rotation. In this system the user can press the spool to move it axially to disengage the cam and vary pressure to regulate retraction. It is fail safe in that if the user lets go, the spool stops and cord retraction is halted, preventing uncontrolled cord retraction and subsequent cord whipping and potential damage or injury. This variation is called Push-to-Stow because in order to stow the extended cord, the user must “push” the spool to disengage the cam allowing the cord to retract.

An alternative to the Push-to-Stow is the Pull-to-Stow where the spool is biased by a spring away from the cam and stationary contacts. The resulting natural state of the Pull-to-Stow cord reel is a disengaged cam with the spool free to rotate and the cord free to be extend or to retract. In this variation, the user pulls the cord to the desired length then pushes an exposed button portion of the spool causing it to move axially and engage the cam and stationary contacts. Once engaged, the cam holds the spool in the axial position and angular position with contacts on the spool mating with contacts on the housing, and the user then can release the cord and it remains extended. To retract the cord, the user pulls on the cord and the spring biased spool moves axially and releases from the cam and contacts, and the spool is free to rotate and the cord will retract. The speed of retraction is regulated by the user who is still holding the cord. This releasing action is similar to that of a window shade where the user pulls slightly, feels the tension of the cord, then allows controlled retraction. As most people have encountered window shades or similar mechanisms, the action of Pull-to-Stow is natural and instinctual. So long as the user holds on to the cord during retraction, cord whipping and potential damage or injury is avoided.

In another variation there would be no axial biasing of the spool, the spool would be free to move axially in either direction. Here, the user would manually push the spool to one side to engage the cam and to the other side to release the spool from the cam. This can be accomplished by pushing or pulling portions of the spool that are exposed through openings in the housing.

In still another variation, the means for moving the spool can also serve to lock the spool once the spool electrical contacts engage the electrical contacts on the housing. In this variation, the means could be an internal part or mechanism such as a lever, pawl or rocker that would automatically engage the spool and push it axially, and the release the spool allowing it to return to the original disengaged axial position, eliminating the need for an external button on the cord reel. For example, incorporating a type of “window shade” mechanism would allow a user to extend a desired length of cord and the spool would automatically lock and move axially to engage electrical contacts. To retract, the simply user tugs on the cord to release the locking mechanism allowing the spool to move axially and disengage from the electrical contacts and retract.

As can be seen, beyond the use of a spring there are an almost an infinite number of other ways to cause the spool to move axially such as levers, additional cams, helical threads on axially engaging parts such as the spindle, using the natural spring properties of the spool, housing or other parts, controlling the direction of the cord as it comes on or off the spool, etc., without departing from the spirit of the invention. Also, the power spring that provides the force to retract the cord can be manufactured to also provide axial force in either axial direction, and the cam or components that control axial movement can mounted on the housing, spool, intermediate parts or combination thereof. Additionally, the entire spool need not move axially but rather only portion of the spool. Further, the cam that controls axial position of the spool or spool portion can be incorporated into various parts other than the spool and housing. For example, a cam on the housing can act on an axial movable spindle, or the cam can be incorporated a non-moving spindle, or the cam can be incorporated into intermediate parts or actuators.

### BRIEF DESCRIPTION OF THE DRAWINGS

FIG. 1 is an exploded front view of a Push-to-Stow cord reel assembly.

FIG. 2 is an exploded rear view of the cord reel assembly of FIG. 1.

FIG. 3 an assembled cord reel assembly of FIG. 1 and FIG. 2.

FIG. 4 is an exploded rear view of a Push-to-Stow cord reel assembly integrated into an electronic device and in electrical communication with a circuit board installed in the housing.

FIG. 5 is a view of the interior of a Push-to-Stow cord reel showing the spool and contacts in the engaged position.

FIG. 6 is an exploded front view of a Pull-to-Stow cord reel assembly.

FIG. 7 is an exploded rear view of the Pull-to-Stow cord reel assembly of FIG. 6.

FIG. 8 an assembled cord reel assembly of FIG. 6 and FIG. 7.

FIG. 9 is an exploded front view of a cord reel assembly with a movable spool portion.

FIG. 10 is an exploded rear view of the cord reel assembly of FIG. 9.

FIG. 11 is an inside view of the Housing Base of the Pull-to-Stow if FIG. 6 showing an alternate step on the cam.

### DETAILED DESCRIPTION

### Non-Limiting Examples and Terminology

As required, detailed examples of the presently claimed invention are disclosed herein; however, it is to be understood that the disclosed variations are merely examples of the presently claimed invention, which can be embodied in various forms. Therefore, specific structural and functional details disclosed herein are not to be interpreted as limiting, but merely as a basis for the claims and as a representative basis for teaching one skilled in the art to variously employ the presently claimed invention in virtually any appropriately detailed structure and function. Further, the terms and phrases used herein are not intended to be limiting; but rather, to provide an understandable description of the presently claimed invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

### Overview of Retractable Cord Reel

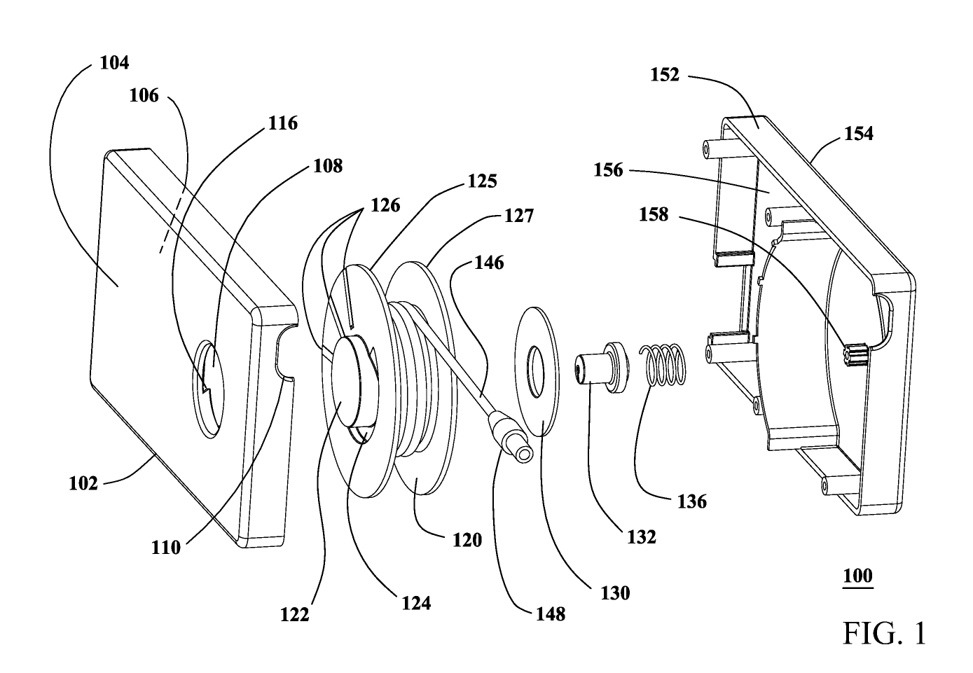

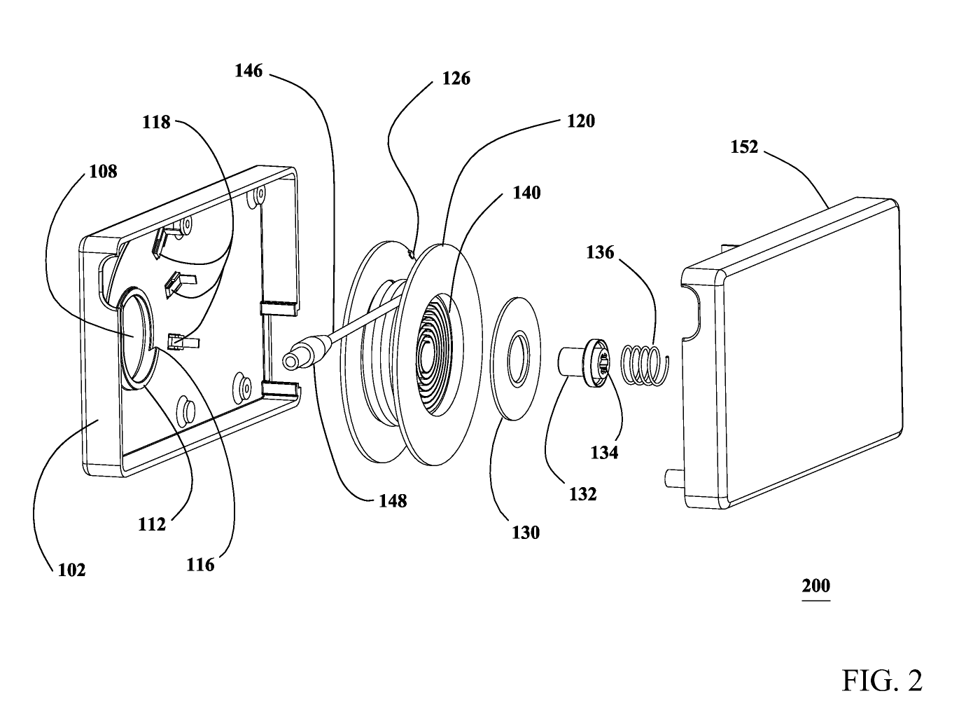

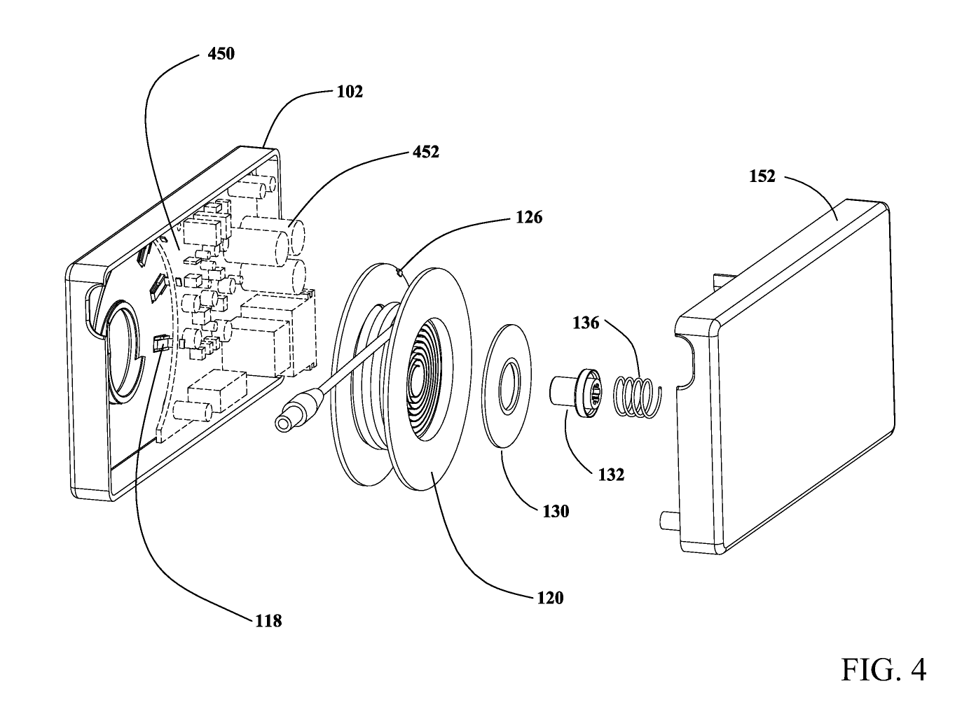

FIGS. 1-5 illustrates a “Push-to-Stow” example cord reel assembly in that a person must push a button to cause the cord to retract and become stowed in the cord reel housing. More specifically, FIG. 1 is an exploded front view 100 of a Push-to-Stow cord reel assembly and FIG. 2 is an exploded rear view 200 of the cord reel assembly of FIG. 1. As can be seen in FIG. 1 and FIG. 2, the retractable cord reel assembly 100, 200 from which a retractable cord 146 can be extended and retracted. The cord reel assembly 100, 200 can be a standalone product where the retractable cord 146 on a spool 120 is electrically connected to one or more stationary wires that are routed out of the cord reel housing. The spool 120 rotates with respect to the housing cover 102. The cord reel assembly 100, 200, in another example is part of an electronic device. In one such example, an electronic circuit board 450 with electrical components 452 mounted thereon is installed alongside the spool in the cord reel housing cover 102 shown in FIG. 4. The retractable cord or cable 146 could be a single or multiple electrical conductor cable that carries data, power or combination of electrical power and/or signals.

The retractable cord reel assembly 100, 200 in one example includes a housing cover 102 adapted to mechanically join to a housing base 152. The housing cover has an outside surface 104 and an inside surface 106. An opening 108 in the housing cover 102 is sized to accommodate the spool button 122 of the spool 120. On the inside surface 106 surrounding the opening, a lockable cam 112, with a cam stop 116 is disposed around the opening 108. The housing cover 102 also includes an opening 110 for the retractable cord 146 to pass thru to the interior of the reel assembly 100.

Spool 120 is sized to fit between the cover 102 and housing base 152. Spool 120 also carries a coil of retractable cord 146. Spool 120 is rotatably mounted on spindle 132. Spindle 132 is slidably mounted on spline 158 which allows spindle 132 to move in the axial direction. Axial bias spring 136 biases spindle 132 in the direction toward cover 102 and cam 112. Biased by spring 136, spindle 132 pushes spool 120 toward housing 102 and cam 112. The spool 120 includes a cam surface 124 to mate with the lockable cam 112 and cam stop 116. As cord 146 is extended from spool 120, spool 120 rotates on spindle 132. The axial biasing of spindle 132 and spool 120 causes cam surface 124 on spool 120 to mate with cam 112.

The spool 120 has a cylindrical center section on which retractable cord 146 is wound. At each end of the cylindrical winding surface is a side wall 125, 127 to contain the retractable cord 146 on the winding surface. A set of spool electrical contacts 126 is disposed on the side wall 125 of the spool 120 as shown. A corresponding set of stationary electrical contacts 118 are disposed on the inside surface 106 of the housing cover 102. As will be described in greater detail below, the stationary electrical contacts 118 are complimentary sized, located and shaped to allow an electrical path to be completed with the electrical contacts 126 when a cam surface 124 of the spool 120 is stopped at a predetermined rotation or a set angular position of the spool 120 by the cam step 116. This alignment of stationary electrical contacts 118 with the spool electrical contacts 126 is shown in FIG. 5.

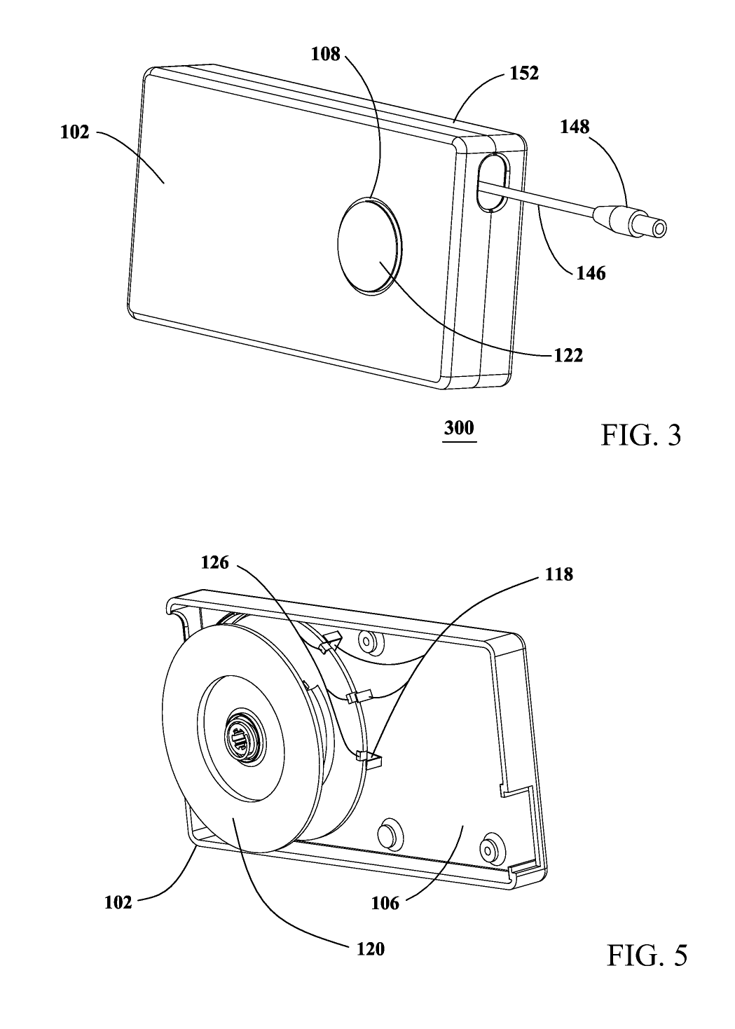

One end of the retractable cord 146 is wound around and attached to the spool 120 and electrically connected to the spool electrical contacts 126 disposed on the side of the spool 120. The opposite end of the retractable cord may be terminated to another device or have a connector 148 as shown. As shown in FIG. 3, the spool 120 when enclosed inside by the housing cover 102 and housing base 152 forms a cord reel assembly 300. A means of retracting the retractable cord 146 around the spool 120 within the cord reel assembly 300 is included. A power spring 140 as shown in FIG. 2 is one means of retracting. Other means of retracting instead of or in addition to the power spring 140 includes other means known in the art, such as, a crank, a motor, or a combination thereof.

The cord reel assembly 300 provides a novel structure for managing and organizing a retractable cord 146. The retractable cord 146 is a data line, a telephone line, an electric cable, any other cable, a wire, or combination thereof.

This example of a cord reel assembly in FIGS. 1-5 is called “Push-to-Stow” because a person must push the spool button 120 to cause the cord to retract and become stowed in the cord reel assembly 300. In one example, the spool 120 is biased for rotation by a power spring 140. The spool 120 is also capable of moving axially within the housing cover 102 and housing base 152. The axial position of spool 120 is biased in one direction by an axis spring. Though the axis bias spring 136 can act directly on the spool, in this variation the axis bias spring 136 acts on a floating or movable spindle 132 on which the spool 120 is mounted. This movable spindle 132 is free to move axially along with the spool 120 but is restrained from rotation relative to the housing cover 102. In this example, rotation is restrained by a by a hollow spline 134 in the movable spindle 132 that matches the spline 158 disposed on the housing base 152. Those skilled in the mechanical field understand that restraining rotation can be accomplished by any number of means, such as, but not limited to keying, non-circular shafts and holes, pins, dogs, notches, pawls, or a combination thereof.

At the one end of the spool is a spool button 122 that extends through an opening 108 in the housing cover 102. Also the spool 120 includes a cam surface 124 that mates with a cam step 116 on the inside wall of the housing cover 102. The axis bias spring 136 urges the spool 120, such that, the cam 112 in the housing cover 102 mates with the cam surface 124 on the spool 120. The mating of cam 112 and cam surface 124 controls the axial position of the spool 120 as it rotates within the housing cover 102. The cam step 116 as the name implies has one or more steps that permit rotation in only one direction acting as a locking means on cam 112. As the retractable cord 146 is extended, the lockable cam 112 allows the spool 120 to rotate freely while the spool 120 moves axially as it rides up and down the high and low spots of the cam 112. When the retractable cord 146 is released, the spool 120 will rotate backwards until a portion of cam surface 124 in the spool 120 engages cam step 116 of the housing cover 102 which stops further retraction of the retractable cord 146. The cord reel device 100, 200 can be configured such that the lockable cam 112, the cam step 116, the spool button 122 or other features can be positioned in different locations and/or on different parts of the cord reel assembly and accomplish the same effect.

A means for locking the angular position of the spool separate from cam 112 such as a fixed or movable follower, a wedge or block, or a separate part such as a lever, rocker or pawl can alternatively replace cam step 116. Such a means can also replace the cam 112 or cam surface 124. In many applications, cam 112 and cam surface 124 (which is actually a complementary cam designed to mate with cam 112) is preferred because it can increase surface area in contact thereby reducing pressure and wear which could be important when parts are manufactured from plastic. In other applications it may be preferable to simply have a protrusion on the surface of the housing that engages a protrusion on the spool when the spool 120 is pushed axially by a means to move the spool. In this application, spool 120 moves from unlocked axial position to another axial position where the spool engages the housing to lock rotation and the spool contacts 126 engage housing contacts 118.

The retractable cord 146 is retracted by pressing on the spool button 122 on spool 120 which is accessible through the opening 108 in the housing cover 102. Pressing the spool button 122 causes the spool 120 to move axially until the spool releases from the cam step 116 allowing the spool 120 to rotate and the retractable cord 146 to retract. If the spool button 122 is pushed too hard, friction between the person's hand and the spool button 122, plus friction of internal parts will cause rotation of spool 120 and retraction of the retractable cord 146 to slow or stop altogether. If the spool button 122 is released, the spool 120 will reengage the cam step 116, stopping the rotation of spool 120 and retraction of the retractable cord 146. Proper and full cord retraction is accomplished by a person exerting a light touch, enough to release the spool 120 from cam step 116 but not enough to stop rotation. This conscious effort to exert a light touch enables the person to control cord retraction speed and distance and avoid uncontrolled retraction and the whipping of the retractable cord 146. The spool button 122 can be a part of the spool 120, a part of a portion of the spool 120, or it could be a completely separate part that causes axial movement of the spool 120.

In the housing cover 102 are stationary electrical contacts 118, stationary in that they are mounted directly or indirectly to the inside 106 of the housing cover 102 and do not rotate with the spool 120. Even though these stationary electrical contacts 118 may move or flex slightly to assure proper pressure to wipe and engage for electrical communication with spool electrical contacts 126, they are still considered stationary.

FIG. 2 shows the stationary electrical contacts 118 mounted to the inside surface 106 of the housing cover 102. FIG. 4 shows the stationary electrical contacts 118 mounted to a circuit board 450 with electronic components 452 installed in the housing cover 102. These stationary electrical contacts 118 are located such that they are in substantial alignment with the corresponding spool electrical contacts 126 on the spool 120 when cam surface 124 on spool 120 engages the cam step 116 in the housing cover 102. Once the retractable cord 146 is extended to the desired distance and released, the spool 120 will rotate backwards until the cam step 116 is engaged. At this angular location, the spool electrical contacts 126 on the spool 120 are in electrical communication with the stationary electrical contacts 118 in the inside surface 106 of the housing cover 102 providing continuity of all contacts from the retractable cord 146 to the stationary electrical contacts 118.

Additionally, the lockable cam 112 and cam surface 124 are designed such that the spool 120 is held axially away from the housing cover 102 so the electrical contacts 118, 126 do not engage during cord extension. It is when the cord is allowed to retract and the spool 120 begins reverse rotation that cam 112 and cam surface 124 cause spool 120 to reach the end of its range of axial motion and the electrical contacts 118, 126 engage or electrically couple. This prevents the contacts from engaging during cord extension. The variations shown in FIGS. 1-5 incorporate a reverse angle in the cam step 116 to accomplish this task. Once the cam surface 124 on spool 120 rides over the edge of the cam step 116, reverse rotation of the spool 120 as it rides on the lockable cam 112 causes the spool 120 to move axially allowing electrical contacts to electrically engage or electrically couple and also the spool 120 to lock into the undercut of the reverse angle step 116. The lockable cam 112 and reverse angle cam step 116 is one many means to accomplish contact after reverse rotation. Those skilled in the art understand there are many other means to accomplish this feature such as helical splines, levers, rollers or a combination thereof without departing from the presently claimed invention.

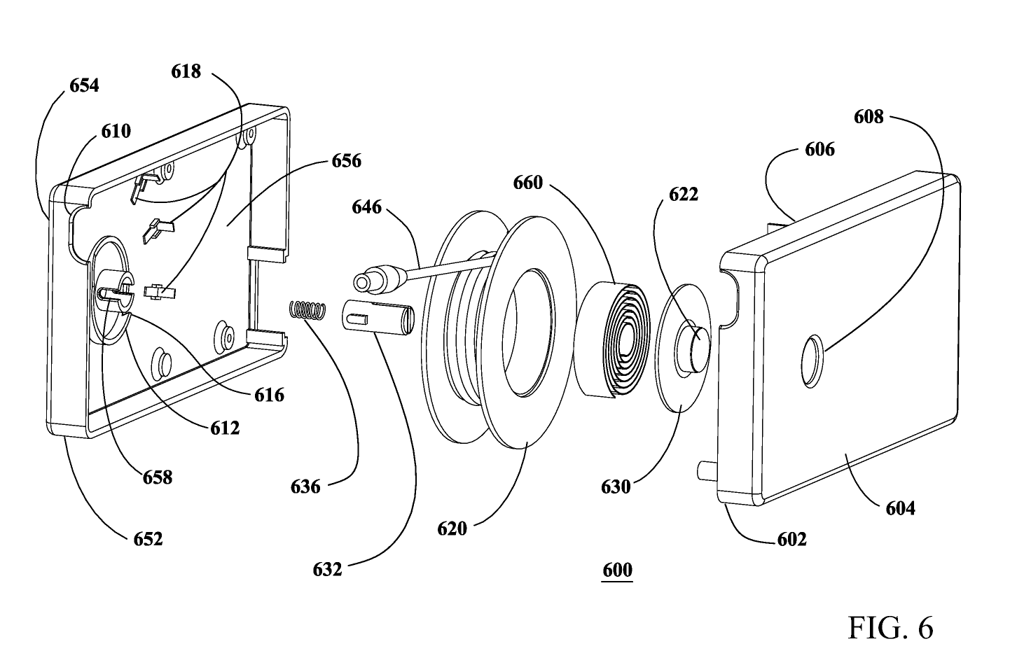

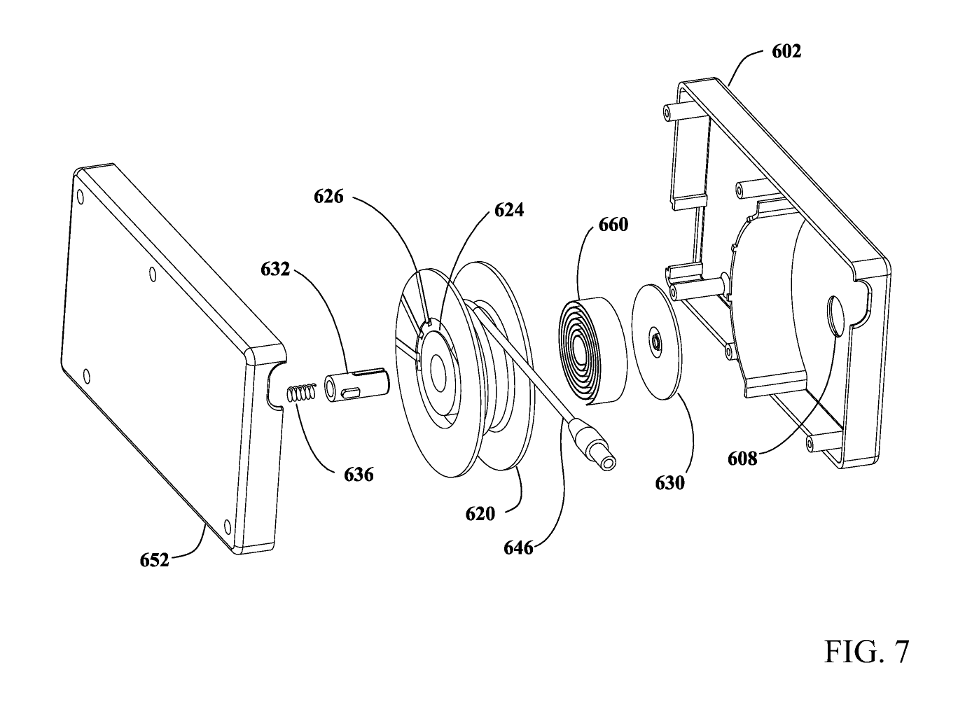

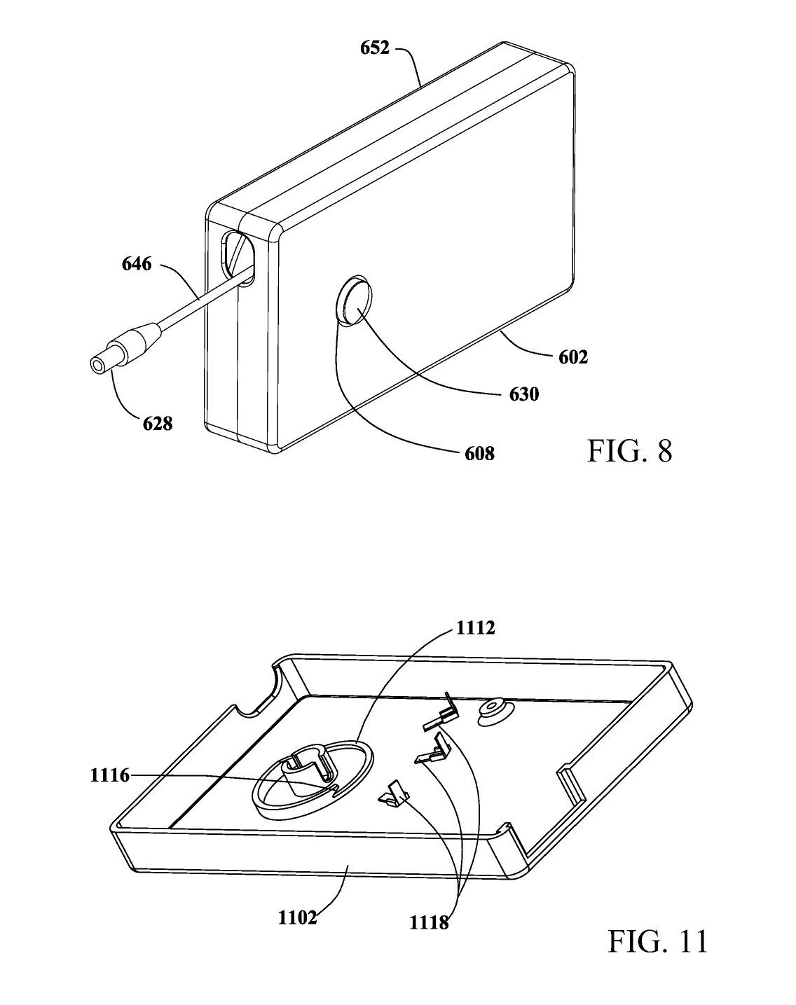

An alternate to the Push-to-Stow is the Pull-to-Stow cord reel assembly 600 as shown in FIGS. 6-8. In the Pull-to-Stow, a person pulls the retractable cord to release the spool 620 from the housing thereby allowing the spool 620 to rotate and retractable cord 646 to retract. Like the Push-to-Stow described above and shown in FIGS. 1-3, the spool 620 is free to move axially to engage stationary electrical contacts 618 to achieve electrical communication between the housing base 652 and the retractable cord 646, and at the same time, engage the cam step 616 to lock the spool 620 from rotation. An important difference of the Pull-to-Stow variation is that the spool 620 is biased in the opposite direction so that the spool 620 is biased away from the cam and stationary electrical contacts 618. This configuration allows the retractable cord 646 to be extended and retracted freely with no engagement of the reverse angle cam or engagement of contacts, until a person pushes the spool 620 and moves it axially to engage the cam step 616 and stationary electrical contacts 618. Similar to the Push-to-Stow, the Pull-to-Stow has a button 622 on spool 620 that is accessible through an opening 608 in the housing cover 602. Since the spool 620 of the Pull-to-Stow is biased away from the cam step 616 and the contacts 618, the spool button 622 of the spool 620 is used to push the spool 620 toward the cam step 616 and stationary electrical contacts 618. To use the cord reel, a person pulls the cord to the desired length then presses the spool button 622. This action compresses axial bias spring 636 and pushes the spool 620 toward the cam step 616 and stationary electrical contacts 618 so when the cord is released the spool 620 will rotate backward and the cam step 616 will engage, and the spool electrical contacts 626 will electrically mate with the stationary electrical contacts 618 in the housing 652.

Since the spool 620 needs to rotate while the spool button 622 is pressed, it is desirable to reduce friction caused by the pressing of the button. In the Push-to-Stow variation, a large button i.e., spool button 122 enabled the pressing action to induce friction to accomplish controlled retraction. In the Pull-to-Stow, the user holds the cord thereby controlling retraction until the cam step 616 engages, and excessive friction can interfere with this action. The Pull-to-Stow variation shown in FIGS. 6-8 has a small diameter button that minimizes the rotational friction of a users hand against the button. Other means obvious to those skilled in the mechanical art can also be employed such as controlling the shape and surface texture of the button or incorporating a separate button actuator with low friction contact with the spool 620 such as a bearing and/or lubricated connection.

An alternative to button 622 in the pull-to-stow variation is to incorporate a locking device such as a pawl, lever or rocker that pushes the spool and/or spindle axially to compress axial bias spring 632 and cause spool contacts 626 to mate with stationary contacts 618 as well as lock spool 620 in the correct angular position. Since spool 620 is biased away from contacts 618 and in this variation there is no button to cause axial movement of the spool, there is no longer a need for cam 612. Spool 620 remains biased away from contacts 618 until the cord is released and spool 620 is allowed to rotate backwards, at which point the locking device engages spool 620 at the appropriate angular position, locks it from rotation, and pushes it axially to close spool contacts 626 and housing contacts 618.

Retraction is accomplished by pulling the retractable cord causing the spool 120 to rotate forward and the cam step 616 to disengage from spool 620. Since the spool 120 is biased away from the lockable cam 612, once the step releases the spool 620 spring 636 causes it to move axially away from the lockable cam 612 and the spool is free to rotate and retract cord 646. When the step disengages, the person pulling the retractable cord 646 will feel tension on the cord as it attempts to retract. The natural response is to continue holding the retractable cord 646 to provide controlled retraction, avoiding the undesirable uncontrolled retraction and the whipping of the retractable cord 646. The Pull-to-Stow mechanism is a very natural and instinctual action, much like a window shade, where a person is inherently reluctant to release a cord under tension and instead allow it to retract in a controlled fashion.

In both the Push-to-Stow and Pull-to-Stow variations, the cam 116, 616 in the housing and the cam surface 124, 624 on the spool 120, 620 are configured such that engagement of electrical contacts 118, 618, with contacts 126, 626 is prevented until they are near angular alignment. The lockable cam 112, 612 keeps the spool 120, 620 away from the housing until contacts are near alignment, then the cam allows the spool 120, 620 to move axially and the contacts to electrically engage or electrically couple. This feature assures that each contact on the spool 120, 620 will contact only its corresponding stationary electrical contact 118, 618 on the housing cover 102, 602.

As can be understood by someone skilled in the art, there are many variations of the above configuration that do not depart from the presently claimed invention. For example, the axis bias spring 136, 636 can be eliminated if a person could manually push the spool 120, 620 to one side or the other. There could be a button on both sides, or a push pull button on one side. The spool 120, 620 need not be accessible through an opening 108, 608 in the housing cover 602 if an actuator or mechanism were incorporated to push or bias the spool 120, 620 one way or the other. Additionally, the spool button 122, 622 portion of the spool 120, 620 can be designed to be pulled rather than pushed.

Another variation would be to have a portion of the spool 120 be mostly fixed in one axial position, and another portion of the spool 120 allowed it to move axially. One example would be to have the cord winding portion of the spool 120 in one axial location, and have the portion of the spool 120 with the cam surface and contacts mounted to a separate spool portion of the spool 120 such that it is allowed to move axially and engage the housing. This partially axially moving spool variation can apply to either the push-to-stow or the pull-to-stow configurations.

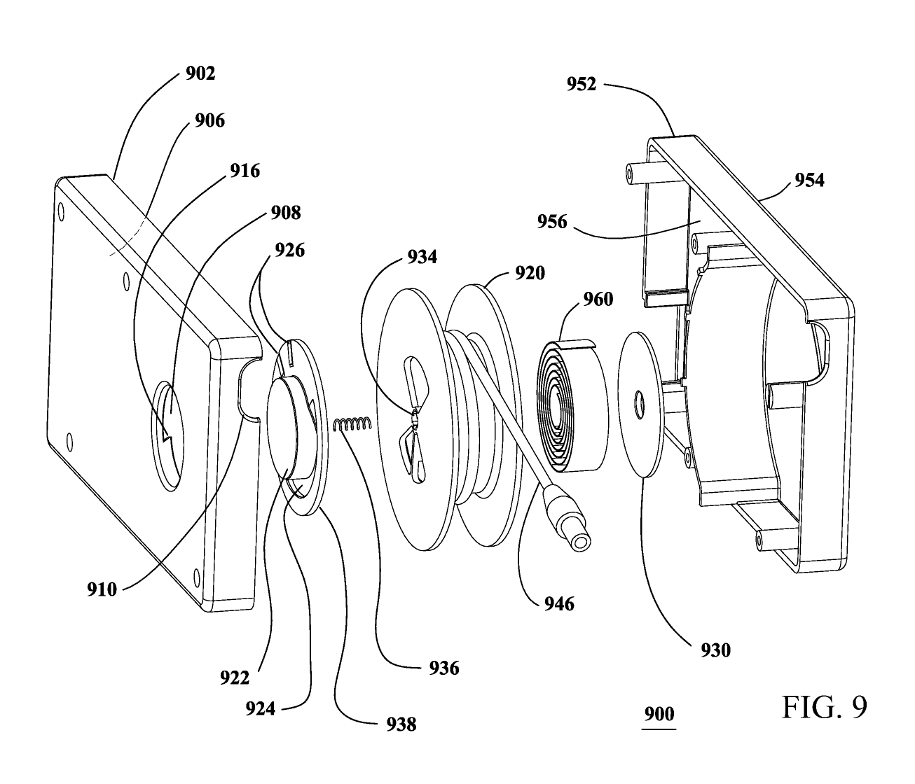

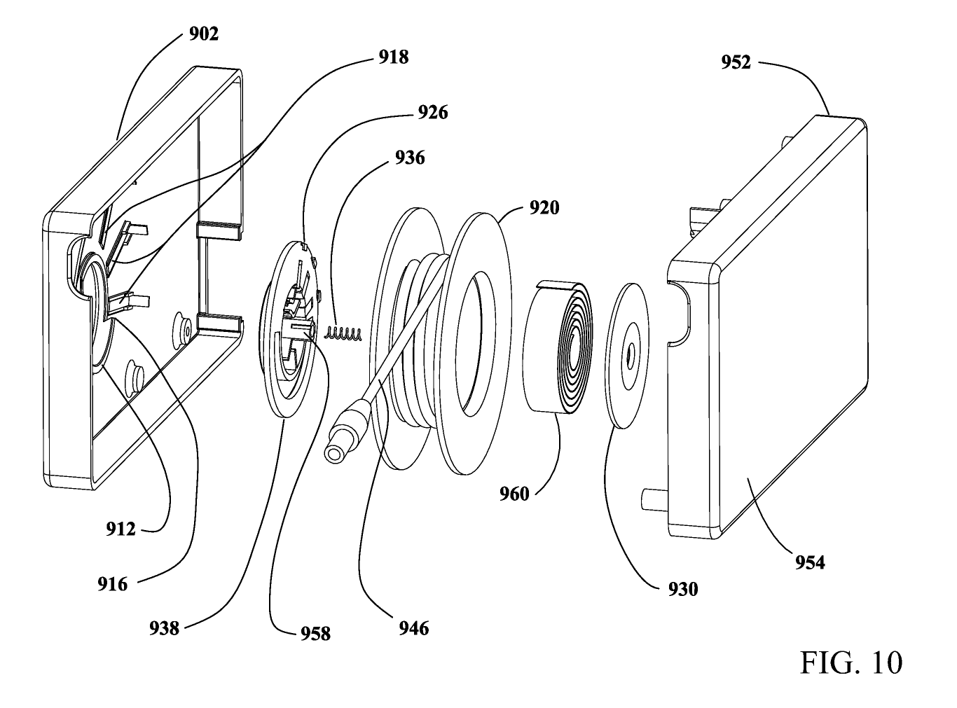

FIGS. 9 and 10 show a variation of the push-to-stow cord reel with an axially movable spool portion that has the cam surface and electrical contacts. The end of the retractable cord that terminates inside the spool 920 is connected to the electrical spool contracts 926 on the movable spool portion 938, this connection it not shown in the figures. The movable spool portion 938 is biased by an axial bias spring 936 similar to the other cord reel variations explained above except it acts to move only the spool portion 938 rather than the entire spool assembly. The spool portion 938 may be keyed to the spool 920 such that it rotates partially or entirely with the spool. One example is keyed shaft 958 on spool portion 938 that fits in keyed hole 934 in spool 920, allowing axial movement of spool portion 938 relative to spool 920 while remaining rotationally coupled.

A variation of the movable spool portion would be to have an axial movable, non-rotating housing portion that can move axially to lock spool rotation and achieve electrical continuity between stationary electrical contacts on the axially movable housing portion and contacts on the spool.

### Non-Limiting Examples

Although specific examples of the invention have been disclosed, those having ordinary skill in the art will understand that changes can be made to the specific examples without departing from the spirit and scope of the invention. The scope of the invention is not to be restricted, therefore, to the specific examples, and it is intended that the appended claims cover any and all such applications, modifications, and examples within the scope of the present invention.

What is claimed is:

1. A retractable cord reel apparatus, the apparatus comprising:
a housing;
at least one stationary electrical contact disposed within the housing;
at least one spool positioned within the housing and arranged to rotate relative to the housing and to move axially within the housing;
a means to move the spool from one axial position to another axial position;
a means for locking an angular position of the spool relative to the housing when the spool is in one axial position; and
at least one spool electrical contact disposed on the spool and configured to electrically couple to the stationary electrical contact when the spool is in one axial position and the spool is locked from rotation relative to the housing.

2. The apparatus of claim 1, where in the means for locking includes a lockable cam, a step, a block, a cam follower, a lever, a rocker, a roller, a pawl, or a combination thereof.

3. The apparatus of claim 2, further comprising:
a retractable cord with at least one electrical conductor capable of being extended from the housing by unwinding from the spool and retracted into the housing by winding onto the spool, and the electrical conductor in electrical communication with the spool electrical contact.

4. The apparatus of claim 3, where during extension of the cord from the housing the spool electrical contact disposed on the spool does not electrically engage the stationary electrical contact disposed within the housing.

5. The apparatus of claim 3, wherein the retractable cord with the at least one electrical conductor, includes a conductor that carries data, power, or a combination thereof.

6. The apparatus of claim 2, where the spool electrical contact disposed on the spool does not electrically couple with the stationary electrical contact disposed within the housing unless the spool is locked from rotation.

7. The apparatus of claim 2, further comprising:
an axial bias spring to urge the spool in an axial direction to contact the means for locking to lock rotation of the spool relative to the housing.

8. The apparatus of claim 7, further comprising:
a spool button mechanically coupled with the spool, whereby the axial bias spring is axially compressed allowing the spool to move axially and rotate relative to the housing when the spool button is depressed.

9. The apparatus of claim 8, wherein the cam further comprising:
at least one cam step to set angular position of the spool relative to the housing.

10. The apparatus of claim 2, further comprising:
an axial bias spring to urge the spool in an axial direction away from stationary contact mounted on the housing.

11. The apparatus of claim 10, further comprising:
a spool button mechanically coupled with the spool, whereby when the button is depressed the spool moves axially toward the means for locking, thereby preventing the spool from rotating relative to the housing when the means for locking engages the spool.

12. The apparatus of claim 10 where a locking mechanism consisting of a movable pawl, lever, rocker, clutch, ball, roller or combination thereof locks the spool in the angular position aligning contacts on the spool with contacts on the housing and moves the spool in the axial direction causing the contacts to mate when the retractable cord is released.

13. A retractable cord reel apparatus, the apparatus comprising:
a housing;
at least one stationary electrical contact mounted within the housing;
at least one spool positioned within the housing and arranged for rotation relative to the housing, the spool having a movable spool portion with at least one spool electrical contact disposed on the movable spool portion; and
at least one lockable cam located within the housing, the lockable cam including a cam step to lock rotation at a set angular position of spool relative to the housing and during locking the stationary electrical contact is electrically coupled to the spool electrical contact.

14. The apparatus of claim 13, further comprising:
a retractable cord with at least one electrical conductor capable of being extended from the housing by unwinding from the spool and retracted into the housing by winding around the spool, and the electrical conductor in electrical communication with the spool electrical contact.

15. The apparatus of claim 14, where during rotation of spool relative to the housing the spool electrical contact disposed on the movable spool portion does not electrically contact the stationary electrical contact disposed within the housing during cord extension and the retractable cord includes two or more electrical conductors.

16. The apparatus of claim 14, wherein the retractable cord with the at least one electrical conductor, includes a conductor that carries data, power, or a combination thereof.

17. The apparatus of claim 13, where the movable spool portion moves in an axial direction.

18. The apparatus of claim 13, where the movable spool portion does not rotate relative to the spool.

19. A retractable cord reel apparatus, the apparatus comprising
a housing;
at least one stationary electrical contact located within the housing;
at least one spool;
at least one retractable cord wound on the spool;
at least one electrical contact mounted on the spool in electrical communication with the retractable cord;
a locking device in the housing to lock the spool from rotation in at least one particular angular location; and
wherein the spool arranged for rotation and axial movement within the housing, and the spool and the locking device providing
a first axial position whereby the electrical contact on the spool engages the stationary electrical contact in the housing and the spool is locked from rotation, and
a second axial position where the electrical contacts on the spool do not engage the stationary electrical contact in the housing and the spool is free to rotate relative to the housing.

20. The apparatus of claim 19, where the electrical contact mounted on the spool does not engage the stationary electrical contact within the housing during extension of the retractable cord.
